(19) United States
(12) Patent Application Publication
(10) Pub. No.: US 2025/0334813 A1
(43) Pub. Date: Oct. 30, 2025

(54) DEVICE FOR EXTENDED REALITY

(71) Applicant: Beijing Zitiao Network Technology Co., Ltd., Beijing (CN)

(72) Inventors: Jiu XIA, Beijing (CN); Pan LIU, Beijing (CN); Guanghui LIU, Beijing (CN)

(21) Appl. No.: 19/066,998

(22) Filed: Feb. 28, 2025

(30) Foreign Application Priority Data
Apr. 24, 2024 (CN) 202410502598.8

(51) Int. Cl. G02B 27/01; G02B 27/00; G06F 1/26; G06F 3/01; G06F 3/16

(52) U.S. Cl. CPC G02B 27/0172; G02B 27/0093; G06F 1/266; G06F 3/013; G06F 3/017; G06F 3/16; G02B 2027/0138; G02B 2027/014

(57) ABSTRACT

The disclosure relates to a device for extended reality, including: a head-mounted display device, a host computer, and an optical fiber connected between the head-mounted display device and the host computer. The head-mounted display device includes a plurality of sensors, an aggregation unit, and a display screen. At least some of the sensors are connected to the aggregation unit. The plurality of sensors are configured to acquire original data. The aggregation unit is configured to aggregate the original data acquired by the sensors connected thereto, to obtain an aggregation result, causing the aggregation result to be transmitted through the optical fiber. The host computer is configured to receive data transmitted through the optical fiber, determine a target image based on the received data, and transmit the target image to the head-mounted display device through the optical fiber.

### CROSS-REFERENCE TO RELATED APPLICATION(S)

This application claims priority to Chinese Application No. 202410502598.8 filed Apr. 24, 2024, the disclosure of which is incorporated herein by reference in its entirety.

### FIELD

The disclosure relates to the field of extended reality technologies, and in particular, to a device for extended reality.

### BACKGROUND

Extended reality (XR) is the combination of reality and virtuality through a computer to create a virtual environment that allows for human-computer interaction, and is also an umbrella term for a variety of technologies such as AR, VR, and MR. Fusion of visual interaction technologies makes an experiencer “immersive” in seamless switching between a virtual world and a physical world.

Most of existing devices for extended reality are all-in-one devices, including head-mounted display devices. A head-mounted display device integrates a sensor, a core processor, and a display screen. The core processor mainly performs calculation based on an image acquired by the sensor, and displays a calculation result to a user through the display screen.

### SUMMARY

In order to solve or at least partially solve the above technical problem, the disclosure provides a device for extended reality.

The disclosure provides a device for extended reality, including: a head-mounted display device, a host computer, and an optical fiber connected between the head-mounted display device and the host computer, where
the head-mounted display device includes a plurality of sensors, an aggregation unit, and a display screen; at least some of the sensors are connected to the aggregation unit;
the plurality of sensors are configured to acquire original data;
the aggregation unit is configured to aggregate the original data acquired by the sensors connected thereto, to obtain an aggregation result, causing the aggregation result to be transmitted through the optical fiber;
the host computer is configured to receive data transmitted through the optical fiber, determine a target image based on the received data, and transmit the target image to the head-mounted display device through the optical fiber; and
the display screen of the head-mounted display device is configured to display the target image.

The disclosure provides a method for extended reality, performed by a device for extended reality, the device for extended reality comprises: a head-mounted display device, a host computer, and an optical fiber connected between the head-mounted display device and the host computer, wherein the head-mounted display device comprises a plurality of sensors, an aggregation unit, and a display screen; at least some of the sensors are connected to the aggregation unit;
wherein the method comprises:
acquiring, by the plurality of sensors, original data;
aggregating, by the aggregation unit, the original data acquired by the sensors connected thereto, to obtain an aggregation result, causing the aggregation result to be transmitted through the optical fiber;
receiving data transmitted through the optical fiber, determining a target image based on the received data, and transmitting, by the host computer, the target image to the head-mounted display device through the optical fiber; and
displaying, by the display screen of the head-mounted display device, the target image.

Compared with the prior art, the technical solution provided in embodiments of the disclosure has the following advantages:
in the technical solution provided in the embodiments of the disclosure, data transmission between the head-mounted display device and the host computer is carried out through the optical fiber; at least some of the sensors in the head-mounted display device are connected to the aggregation unit; the plurality of sensors are configured to acquire the original data; the aggregation unit is configured to aggregate the original data acquired by the sensors connected thereto, to obtain the aggregation result, causing the aggregation result to be transmitted through the optical fiber; the host computer is configured to receive the data transmitted through the optical fiber, determine the target image based on the received data, and transmit the target image to the head-mounted display device through the optical fiber; and the display screen of the head-mounted display device is configured to display the target image. The essence of the technical solution lies in that a core processor for data calculation is integrated in the host computer instead of the head-mounted display device, and the data acquired by at least some of the sensors is aggregated and then transmitted to the host computer.

### BRIEF DESCRIPTION OF THE DRAWINGS

The accompanying drawings herein, which are incorporated into and form a part of the description, illustrate the embodiments in line with the disclosure and are used in conjunction with the description to explain the principles of the disclosure.

In order to more clearly illustrate the technical solutions in the embodiments of the disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a block diagram of a structure of a device for extended reality according to an embodiment of the disclosure;

FIG. 2 is a diagram of a principle of an aggregation unit according to an embodiment of the disclosure;

FIG. 3 is a schematic diagram of connection between an aggregation unit and other components according to an embodiment of the disclosure; and

FIG. 4 and FIG. 5 are block diagrams of structures of two other devices for extended reality according to an embodiment of the disclosure.

### DETAILED DESCRIPTION OF EMBODIMENTS

For a clearer understanding of the above objectives, features, and advantages of the disclosure, the solutions of the disclosure will be further described below. It should be noted that the embodiments of the disclosure and features in the embodiments may be combined with each other without conflict.

Many specific details are set forth in the following description to facilitate a full understanding of the disclosure. However, the disclosure may also be implemented in other ways different from those described herein. Apparently, the embodiments in this specification are only some rather than all of the embodiments of the disclosure.

Since the core processor generates a lot of heat during the calculation process, in order to ensure normal operation of the device and avoid overheating, it is usually necessary to incorporate a heat dissipation fan and a heat dissipation fin into the head-mounted display device. Despite being conductive to heat dissipation, such a design leads to an increase in weight and thickness of the head-mounted display device, affecting the wearing experience of the user.

The present application provides a device for extended reality. The device for extended reality includes: a head-mounted display device, a host computer, and an optical fiber connected between the head-mounted display device and the host computer, where the head-mounted display device includes a plurality of sensors, an aggregation unit, and a display screen; at least some of the sensors are connected to the aggregation unit; the plurality of sensors are configured to acquire original data; the aggregation unit is configured to aggregate the original data acquired by the sensors connected to the aggregation unit, to obtain an aggregation result, causing the aggregation result to be transmitted through the optical fiber; the host computer is configured to receive data transmitted through the optical fiber, determine a target image based on the received data, and transmit the target image to the head-mounted display device through the optical fiber; and the display screen of the head-mounted display device is configured to display the target image.

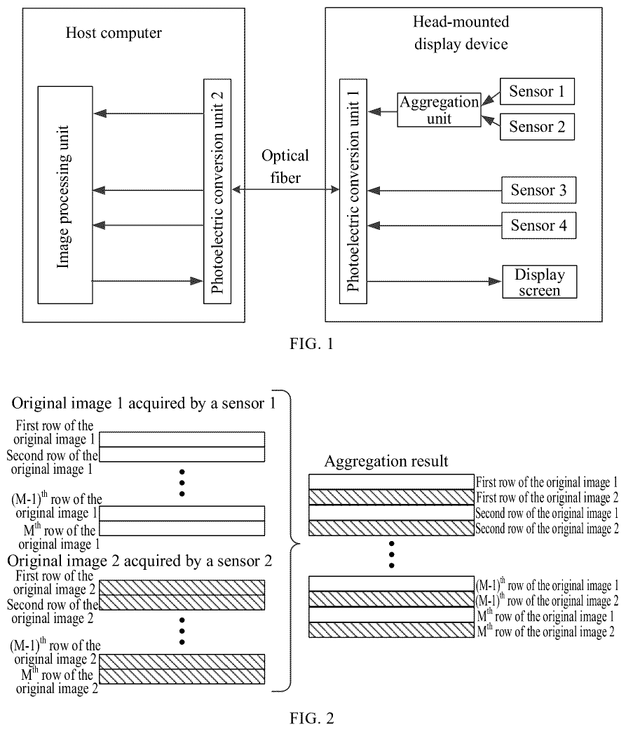

FIG. 1 is a block diagram of a structure of a device for extended reality according to an embodiment of the disclosure. For example, referring to FIG. 1, in the device for extended reality, data transmission between a head-mounted display device and a host computer is carried out through an optical fiber. The head-mounted display device includes a plurality of sensors, an aggregation unit, a photoelectric conversion unit 1, and a display screen. The plurality of sensors includes a sensor 1, a sensor 2, a sensor 3, and a sensor 4. The sensor 1 and the sensor 2 are connected to the aggregation unit, and the aggregation unit is connected to the photoelectric conversion unit 1. The sensor 3 and the sensor 4 are not connected to the aggregation unit, but are directly connected to the photoelectric conversion unit 1. The display screen is connected to the photoelectric conversion unit 1. The host computer includes an image processing unit (i.e., the core processor mentioned in the BACKGROUND) and a photoelectric conversion unit 2. The image processing unit is a key component in the device for extended reality, and is responsible for processing a variety of control signals such as images, audio, and orientation data. The image processing unit may receive and process information from the sensor and another input device, and analyzes and processes the data in real time so as to generate a high-quality and realistic image. The image processing unit is connected to the photoelectric conversion unit 2.

During the operation of the device for extended reality, original data acquired by the sensor 1 and the sensor 2 is aggregated by the aggregation unit and then transmitted to the photoelectric conversion unit 1, to form an optical signal. The optical signal is transmitted to the photoelectric conversion unit 2 through the optical fiber, and the photoelectric conversion unit 2 converts the received optical signal into an electrical signal, and transmits the electrical signal to the image processing unit. The image processing unit performs calculation based on all received signals (including data acquired by the sensor 1, data acquired by the sensor 2, data acquired by the sensor 3, and data acquired by the sensor 4), to obtain a target image that needs to be displayed, and transmits the target image in the form of an electrical signal to the photoelectric conversion unit 2. The photoelectric conversion unit 2 converts the received electrical signal into an optical signal, which is transmitted to the photoelectric conversion unit 1 through the optical fiber. The photoelectric conversion unit 1 converts the received optical signal into an electrical signal, and transmits the electrical signal to the display screen, causing the display screen to display the target image.

That “the aggregation unit is configured to aggregate the original data acquired by the sensors connected to the aggregation unit” may, for example, mean that the aggregation unit concatenates a plurality of pieces of original data acquired by the sensors connected thereto into one piece of data (i.e., the aggregation result, which may also be referred to as a signal). An amount of data that needs to be transmitted can be reduced through aggregation, thereby reducing the number of signal lines that need to be used.

Optionally, the aggregation unit is configured to perform interleaved aggregation on the original data acquired by the sensors connected thereto, to form the aggregation result.

For example, the sensors are connected to the aggregation unit through a signal lines. During the process of transmitting the original data from the sensors to the aggregation unit, one row of pixels in the original data is transmitted through one signal line, and the signal lines perform pixel transmission in parallel. The aggregation unit concatenates the rows of pixels obtained from the sensors row by row according to a preset sensor arrangement order, to obtain the aggregation result.

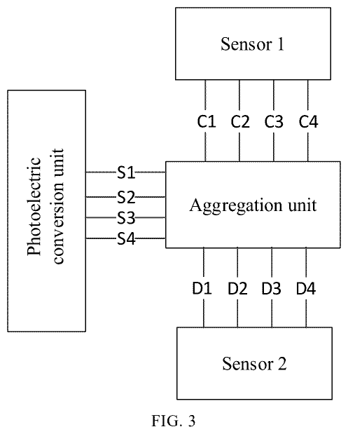

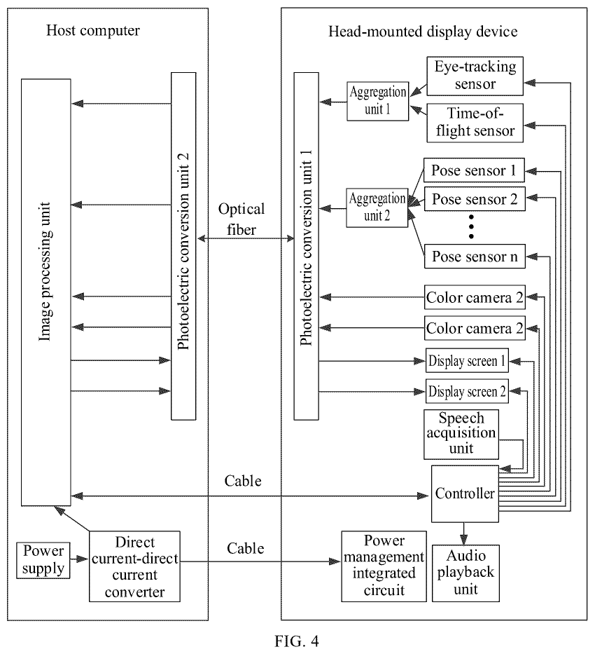

For example, referring to FIG. 2 and FIG. 3, if the sensor 1 acquires an original image 1, the sensor 1 is connected to the aggregation unit through four signal lines. The 1st, 5th, 9th . . . rows of pixels of the original image 1 are transmitted through a first signal line C1. The 2nd, 6th, 10th . . . rows of pixels of the original image 1 are transmitted through a second signal line C2. The 3rd, 7th, 11th . . . rows of pixels of the original image 1 are transmitted through a third signal line C3. The 4th, 8th, 12th . . . rows of pixels of the original image 1 are transmitted through a fourth signal line C4. The sensor 2 acquires an original image 2, and the sensor 2 is connected to the aggregation unit through four signal lines. The 1st, 5th, 9th . . . rows of pixels of the original image 2 are transmitted through a first signal line D1. The 2nd, 6th, 10th . . . rows of pixels of the original image 2 are transmitted through a second signal line D2. The 3rd, 7th, 11th . . . rows of pixels of the original image 2 are transmitted through a third signal line D3. The 4th, 8th, 12th . . . rows of pixels of the original image 2 are transmitted through a fourth signal line D4. In addition, the preset sensor arrangement order is the sensor 1, the sensor 2.

The aggregation unit is connected to the photoelectric conversion unit through four signal lines. The aggregation result output from the aggregation unit is an electrical signal, and the photoelectric conversion unit is configured to convert the aggregation result in the form of an electrical signal into an optical signal, causing the aggregation result to be transmitted to the host computer through the optical fiber.

After receiving the first row of pixels of the original image 1, and the first row of pixels of the original image 2, the aggregation unit concatenates the two rows of pixels according to the preset sensor arrangement order, to obtain an aggregation result 1. The aggregation result 1 includes the first row of pixels of the original image 1, and the first row of pixels of the original image 2. In the aggregation result 1, the first row of pixels of the original image 1 precedes the first row of pixels of the original image 2. The aggregation unit transmits the aggregation result 1 to the photoelectric conversion unit through a first signal line S1, causing the photoelectric conversion unit to convert the aggregation result 1 in the form of an electrical signal into an optical signal. After receiving the second row of pixels of the original image 1, and the second row of pixels of the original image 2, the aggregation unit concatenates the two rows of pixels according to the preset sensor arrangement order, to obtain an aggregation result 2. The aggregation result 2 includes the second row of pixels of the original image 1, and the second row of pixels of the original image 2. In the aggregation result 2, the second row of pixels of the original image 1 precedes the second row of pixels of the original image 2. The aggregation unit transmits the aggregation result 2 to the photoelectric conversion unit through a second signal line S2, causing the photoelectric conversion unit to convert the aggregation result 2 in the form of an electrical signal into an optical signal, and so on.

Apparently, if the sensor 1 and the sensor 2 are set to directly connect to the photoelectric conversion unit, eight signal lines are needed. The aggregation unit is added between the sensor (including the sensor 1 and the sensor 2) and the photoelectric conversion unit, causing the number of signal lines that need to be set to be connected to the photoelectric conversion unit can be reduced, and subsequently the number of optical fibers that need to be set is reduced.

It should be noted that in practice, there are a plurality of aggregation manners of the aggregation unit, and the “row-by-row interleaved aggregation” described above is only one of the aggregation manners. In practice, another piece of original data may be further concatenated after a complete piece of original data is received. For example, original data 2 is concatenated after original data 1, so that any row of pixels in the original data 1 precedes any row of pixels in the original data 2. Compared with this aggregation manner, the “row-by-row interleaved aggregation” has the advantages of saving memory and reducing a data transmission delay.

It should be noted that in practice, that “at least some of the sensors are connected to the aggregation unit” may be that all the sensors in the head-mounted display device are connected to a same aggregation unit. Alternatively, the head-mounted display device may include a plurality of aggregation units, all the sensors in the head-mounted display device may be divided into a plurality of groups, and the groups are in a one-to-one correspondence with the aggregation units. The sensors in each group are connected to the aggregation unit corresponding to the group. Optionally, all the sensors in the head-mounted display device may be divided into two major groups, and the sensors in a first major group are connected to the aggregation unit. The sensors in a second major group are not connected to the aggregation unit. Further, alternatively, the sensors in the first major group may be further divided into a plurality of subgroups, the head-mounted display device includes a plurality of aggregation units, and the subgroups are in a one-to-one correspondence with the aggregation units. The sensors in each subgroup are connected to the aggregation unit corresponding to the subgroup.

In practice, optionally, the sensors connected to the aggregation unit include at least one or more of the following: an eye-tracking sensor, a gesture camera, a pose sensor, and a time-of-flight sensor.

The eye-tracking sensor may be, for example, configured to capture an image of pupils of a wearer of the head-mounted display device, and a size and dynamic change of the pupils may be measured subsequently based on the image captured by the eye-tracking sensor, to perform head and eye tracking, such as determining a visual focus of a user. Optionally, the eye-tracking sensor may include a pupil camera.

The gesture camera may be, for example, configured to capture an image of a gesture of the user, which is applicable to a situation where the device for extended reality does not include a hand controller. Optionally, the gesture camera may be, for example, a black-and-white camera or another camera.

The time-of-flight (ToF) sensor may be, for example, a sensor configured to calculate a distance between a transmitter and a reflector by measuring a time of flight of signals such as an ultrasonic wave, a microwave, and light between the transmitter and the reflector. In a scenario where the device for extended reality is used, the time-of-flight sensor is configured to measure a distance between the wearer of the head-mounted display device and an object around the wearer.

The pose sensor may be, for example, a sensor configured to detect and measure a position and orientation of the wearer of the head-mounted display device, and data acquired by the pose sensor may describe a change in degrees of freedom in three linear (X, Y, and Z) directions and/or three rotations (roll, pitch, yaw) directions. Optionally, the pose sensor may include at least one of a 3-degree-of-freedom (3DOF) sensor, a 6-degree-of-freedom (6DOF) sensor, and an inertial measurement unit (IMU). It should be emphasized that in practice, one or more pose sensors may be set in the device for extended reality. Further, if the device for extended reality has a hand controller paired therewith, the pose sensor in the head-mounted display device may further detect and measure a pose of the handle relative to the head-mounted display device, or a pose of the head-mounted display device relative to the handle.

In practice, the sensors in the head-mounted display device may further include a color camera. The color camera may be, for example, a camera that captures pictures of the surroundings of the wearer of the head-mounted display device. In practice, two color cameras may be set in the device for extended reality. One color camera is configured to simulate a left eye of the wearer of the head-mounted display device, and an image acquired by the color camera is used to simulate an image that the left eye of the wearer of the head-mounted display device views. The other color camera is configured to simulate a right eye of the wearer of the head-mounted display device, and an image acquired by the color camera is used to simulate an image that the right eye of the wearer of the head-mounted display device views.

In practice, a connection relationship between the aggregation unit and the sensors may be determined based on information such as the number of rows of and resolution of the original data acquired by the sensor, and a bandwidth required for data transmission.

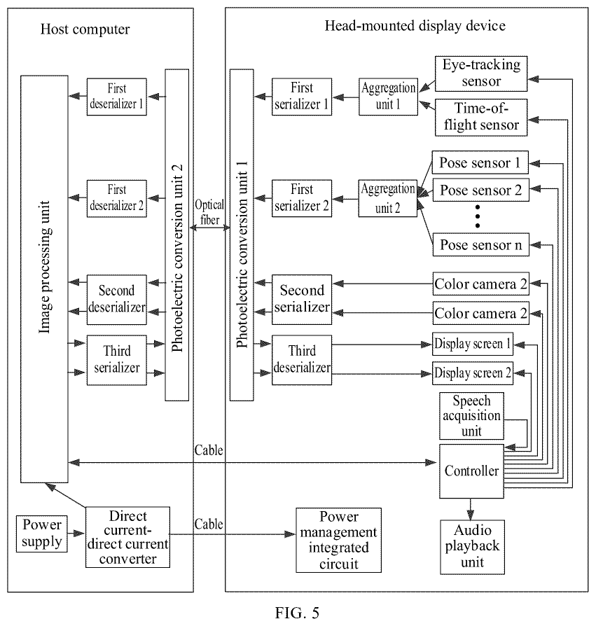

For example, referring to FIG. 4, the sensors set in the head-mounted display device may specifically include: an eye-tracking sensor, a time-of-flight sensor, a plurality of pose sensors, and color cameras. During the determining of the connection relationship between the aggregation unit and the sensors, in consideration of the information such as the number of rows of and the resolution of the original data acquired by the sensor, and the bandwidth required for data transmission, the eye-tracking sensor, the time-of-flight sensor, and the plurality of pose sensors are used as the sensors in the first major group, and the color cameras are used as the sensors in the second major group. The sensors in the first major group are all connected to the aggregation unit. The sensors in the second major group are not connected to the aggregation unit. The first major group is divided into two subgroups: a first subgroup and a second subgroup. The eye-tracking sensor and the time-of-flight sensor are used as the sensors in the first subgroup. The plurality of pose sensors are used as the sensors in the second subgroup. The sensors in the first subgroup are connected to an aggregation unit 1, and the sensors in the second subgroup are connected to an aggregation unit 2. By appropriately setting the connection relationship between the sensors and the aggregation unit, it is beneficial to reduce the requirements of data aggregation and data transmission on device performance and reduce the data transmission delay. Optionally, the pose sensor in this example is a 6-degree-of-freedom sensor.

In some other embodiments, optionally, the time-of-flight sensor, some of the pose sensors, and some of the gesture cameras may be used as the sensors in the first subgroup, and are connected to one aggregation unit; and the eye-tracking sensor, other pose sensors, and other gesture cameras are used as the sensors in the second subgroup, and are connected to the other aggregation unit. Alternatively, all the pose sensors and all the gesture cameras are used as the sensors in the first subgroup, and are connected to one aggregation unit; and the time-of-flight sensor and the eye-tracking sensor are used as the sensors in the second subgroup, and are connected to the other aggregation unit. Alternatively, all the pose sensors, all the gesture cameras, and the time-of-flight sensor are used as the sensors in the first subgroup, and are connected to one aggregation unit; and the eye-tracking sensor is used as the sensor in the second subgroup, and is connected to the other aggregation unit. These design solutions help reduce the requirements of data aggregation and data transmission on device performance and reduce the data transmission delay.

It should be noted that the reason for selecting the optical fiber rather than the cable to transmit the original data acquired by the sensor, the aggregation result, and the target image in the above solution is that an insertion loss and diameter of the optical fiber are small, and the photoelectric conversion unit used with the optical fiber can further reduce the number of optical fibers required.

It should be noted that in the present application, the head-mounted display device does not include a heat dissipation apparatus. In fact, in the head-mounted display device, all circuits and units excluding the sensors, display screens, and necessary circuits for data transmission control are relocated to the host computer, to reduce the weight of the head-mounted display device. Herein, the circuits for data transmission control specifically refer to a circuit for transmitting a signal acquired by the sensor to the host computer, a circuit for receiving a signal transmitted back from the host computer, a controller, and a circuit that connects the controller to the sensor, which are mentioned in the present application.

In the above technical solution, data transmission between the head-mounted display device and the host computer is carried out through the optical fiber. At least some of the sensors in the head-mounted display device are connected to the aggregation unit. The plurality of sensors are configured to acquire the original data. The aggregation unit is configured to aggregate the original data acquired by the sensors connected thereto, to obtain an aggregation result, causing the aggregation result to be transmitted through the optical fiber. The host computer is configured to receive data transmitted through the optical fiber, determine a target image based on the received data, and transmit the target image to the head-mounted display device through the optical fiber. The display screen of the head-mounted display device is configured to display the target image. The essence of the technical solution lies in that a core processor for data calculation is integrated in the host computer instead of the head-mounted display device, and the data acquired by at least some of the sensors is aggregated and then transmitted to the host computer. According to this solution, since the core processor is not integrated in the head-mounted display device, heat generated by the core processor during the calculation process has no impact on the head-mounted display device, and there is no need to set a heat dissipation fan and a heat dissipation fin in the head-mounted display device, thereby reducing a weight of the head-mounted display device. In addition, since the aggregation unit is set, and the optical fiber is used, a thickness and weight of a cable connected between the head-mounted display device and the host computer can be reduced, thereby improving the wearing experience of users.

Based on the above technical solution, the host computer of the device for extended reality further includes a deaggregation unit, which is connected between the photoelectric conversion unit 2 and the image processing unit, or is integrated with the image processing unit. The photoelectric conversion unit 2 converts the received optical signal into an electrical signal, which includes the aggregation result. The deaggregation unit performs deaggregation on the aggregation result, to restore the aggregation result to the original data acquired by the sensor.

On the basis of the above technical solution, in some embodiments, optionally, the sensors set in the head-mounted display device include the inertial sensor. The inertial sensor is not connected to the aggregation unit, but connected to the controller, and data acquired by the inertial sensor is transmitted by the controller to the image processing unit in the host computer through the cable. Alternatively, the inertial sensor is neither connected to the aggregation unit nor connected to the controller, but is directly connected to the image processing unit through the cable, thereby ensuring that the data acquired by the inertial sensor can be transmitted in time.

On the basis of the above technical solution, optionally, the head-mounted display device further includes a first serializer, and the host computer includes an image processing unit and a first deserializer. The first serializer is connected to the aggregation unit. The first deserializer is connected to the image processing unit. The first serializer is configured to convert the aggregation result into a first serial signal, and transmit the first serial signal to the first deserializer through the optical fiber. The first deserializer is configured to receive the first serial signal, perform deserialization on the first serial signal, and transmit a signal obtained by the deserialization to the image processing unit. Transmitting the data in the form of serial data can further reduce the number of signal lines required, thereby reducing the thickness and weight of the cable connected between the head-mounted display device and the host computer.

For example, referring to FIG. 5, a first serializer 1 is connected to an aggregation unit 1. A first deserializer 1 is connected to the image processing unit. Original data acquired by the eye-tracking sensor and the time-of-flight sensor is aggregated, to form an aggregation result a. The first serializer 1 processes the aggregation result a into first serial data a. The photoelectric conversion unit 1 converts the serial data a into an optical signal a. The optical signal a is transmitted to the first deserializer 1 through the optical fiber. The first deserializer 1 performs deserialization on the serial data a, and transmits a signal obtained by the deserialization to the image processing unit. In this case, the deaggregation unit is connected between the first deserializer 1 and the image processing unit, or is integrated with the image processing unit.

A first serializer 2 is connected to an aggregation unit 2. A first deserializer 2 is connected to the image processing unit. Original data acquired by n pose sensors is aggregated, to form an aggregation result b. The first serializer 2 processes the aggregation result b into first serial data b. The photoelectric conversion unit 1 converts the serial data b into an optical signal b. The optical signal b is transmitted to the first deserializer 2 through the optical fiber. The first deserializer 2 performs deserialization on the serial data b, and transmits a signal obtained by the deserialization to the image processing unit. In this case, the deaggregation unit is connected between the first deserializer 2 and the image processing unit, or is integrated with the image processing unit.

Further, referring to FIG. 5, the head-mounted display device may further include a second serializer and a color camera, and the host computer may include an image processing unit and a second deserializer. The second serializer is connected to the color camera. The second serializer is configured to convert original data acquired by the color camera into a second serial signal, and transmit the second serial signal to the second deserializer through the optical fiber. The second deserializer is configured to receive the second serial signal, perform deserialization on the second serial signal, and transmit a signal obtained by the deserialization to the image processing unit. Such setup can further reduce the number of signal lines required, thereby reducing the thickness and weight of the cable connected between the head-mounted display device and the host computer.

Further, referring to FIG. 5, the host computer may further include an image processing unit and a third serializer, and the head-mounted display device may further include a third deserializer. The image processing unit is connected to the third serializer, and the third deserializer is connected to the display screen. The third serializer is configured to convert the target image into a third serial signal, and transmit the third serial signal to the third deserializer through the optical fiber. The third deserializer is configured to receive the third serial signal, perform deserialization on the third serial signal, and transmit a signal obtained by the deserialization to the display screen. Such setting can further reduce the number of signal lines required, thereby reducing the thickness and weight of the cable connected between the head-mounted display device and the host computer.

It should be noted that in FIG. 5, the head-mounted display device includes two display screens, which are respectively a display screen 1 and a display screen 2. In practice, optionally, the display screen 1 is configured to display an image viewed by a left eye. The display screen 2 is configured to display an image viewed by a right eye.

On the basis of the above technical solution, optionally, the device for extended reality may further include a cable. The head-mounted display device further includes a controller. The host computer includes an image processing unit. The image processing unit is connected to the controller through the cable, and the controller is connected to the plurality of sensors. The image processing unit is configured to form a synchronization signal, causing the synchronization signal to be transmitted to the controller through the cable. The controller is configured to generate a first control signal, to control the plurality of sensors to perform data acquisition through the first control signal. The controller is further configured to receive a feedback signal formed after the plurality of sensors perform data acquisition, and obtain a second control signal based on the feedback signal and the synchronization signal, to transmit the second control signal to the image processing unit through the cable.

The synchronization signal is used to synchronize the time between two devices, and may specifically be a continuous pulse signal, etc.

Further, the image processing unit is further configured to calculate the received original data based on the second control signal and the synchronization signal, to obtain the target image, and a third control signal that is associated with the target image. The third control signal is transmitted to the controller through the cable. The controller is further configured to control, based on the third control signal, the display screen to display the target image.

Optionally, the second control signal includes a timestamp of the original data. The third control signal includes a timestamp of the target image.

For example, referring to FIG. 5, the controller is connected to the eye-tracking sensor, the time-of-flight sensor, the pose sensors, the color cameras, and the display screens, and the controller generates a first control signal for controlling one or more of the eye-tracking sensor, the time-of-flight sensor, the pose sensors, and the color cameras to perform data acquisition. The sensors (such as the eye-tracking sensor, the time-of-flight sensor, the pose sensor, or the color camera) form a feedback signal after performing data acquisition, and send the feedback signal to the controller. The controller determines, based on the feedback signal and the synchronization signal, the timestamp of the original data acquired by the sensors, to form a second control signal. The second control signal is transmitted to the image processing unit of the host computer through the cable. Since the second control signal includes the timestamp of the original data, the image processing unit may calculate, based on the timestamp of the original data, the data acquired by the sensors, so that data from different sensors may be aligned to a same temporal reference system, thereby implementing fusion and collaborative calculation of multi-source data. A calculation result obtained by the image processing unit includes a target image and a timestamp of the target image, and the target image is transmitted back to the display screens of the head-mounted display device through the optical fiber. The timestamp of the target image is transmitted as a third control signal to the controller of the head-mounted display device through the cable. The controller then controls the display screens to sequentially display the target image based on the timestamp of the target image.

Since efficiency of data transmission through the cable is higher than efficiency of data transmission through the optical fiber, the transmission of the synchronization signal, the second control signal, and the third control signal through the cable can ensure the timeliness of transmission of the synchronization signal, the second control signal, and the third control signal, thereby reducing a system delay due to the synchronization signal, the second control signal, and the third control signal being not transmitted to the corresponding receiving terminals in time.

On the basis of the above technical solution, optionally, the head-mounted display device further includes a speech acquisition unit and an audio playback unit, and the speech acquisition unit and the audio playback unit are both connected to the controller.

The controller is further configured to generate a fourth control signal, which is used to control the speech acquisition unit to perform speech acquisition, to obtain first speech information. The controller is further configured to receive the first speech information acquired by the speech acquisition unit, obtain second speech information based on the first speech information and the synchronization signal, and transmit the second speech information to the image processing unit through the cable. The image processing unit is further configured to calculate the received original data based on the second control signal, the synchronization signal, and the second speech information, to obtain the target image, and the third control signal and an audio signal that are associated with the target image. The target image, and the third control signal and the audio signal that are associated with the target image are transmitted to the controller through the cable. The controller is further configured to transmit the audio signal to the audio playback unit, causing the audio playback unit to play audio information.

The second speech information includes the first speech information, and a timestamp of the first speech information.

The purpose of such setup is to enable the image processing unit to calculate, based on the second speech information, the original data acquired by other sensors, to ensure that the obtained target image is accurate.

Optionally, still referring to FIG. 5, the host computer further includes a power supply and a direct current-direct current converter, and the head-mounted display device further includes a power supply management integrated circuit. The power supply is connected to the direct current-direct current converter. The direct current-direct current converter is connected to the power supply management integrated circuit through a cable. In addition, in the host computer, the direct current-direct current converter is further connected to the image processing unit, to supply power to the image processing unit. The power supply and the direct current-direct current converter are set on the host computer, causing the weight of the head-mounted display device to be further reduced, thereby improving the wearing experience of users. Optionally, the power supply includes a battery.

It should be noted that the relational terms such as “first” and “second” herein are only used to distinguish one entity or operation from another, and do not necessarily require or imply that any actual relationship or sequence exists between these entities or operations. Moreover, the terms “include” and “including”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The above description illustrates merely specific implementations of the disclosure, so that a person skilled in the art can understand or implement the disclosure. Various modifications to these embodiments are apparent to a person skilled in the art, and the general principle defined herein may be practiced in other embodiments without departing from the spirit or scope of the disclosure. Therefore, the disclosure is not limited to the embodiments described herein but is to be accorded the broadest scope consistent with the principle and novel features disclosed herein.

I/We claim:

1. A device for extended reality, comprising: a head-mounted display device, a host computer, and an optical fiber connected between the head-mounted display device and the host computer, wherein
the head-mounted display device comprises a plurality of sensors, an aggregation unit, and a display screen; at least some of the sensors are connected to the aggregation unit;
the plurality of sensors are configured to acquire original data;
the aggregation unit is configured to aggregate the original data acquired by the sensors connected thereto, to obtain an aggregation result, causing the aggregation result to be transmitted through the optical fiber;
the host computer is configured to receive data transmitted through the optical fiber, determine a target image based on the received data, and transmit the target image to the head-mounted display device through the optical fiber; and
the display screen of the head-mounted display device is configured to display the target image.

2. The device according to claim 1, wherein the sensors connected to the aggregation unit comprise at least one of the following:
an eye-tracking sensor, a gesture camera, a pose sensor, and a time-of-flight sensor.

3. The device according to claim 1, wherein the aggregation unit is configured to aggregate the original data acquired by the sensors connected thereto, to obtain the aggregation result.

4. The device according to claim 1, wherein the head-mounted display device further comprises a first serializer, and the host computer comprises an image processing unit and a first deserializer; the first serializer is connected to the aggregation unit; the first deserializer is connected to the image processing unit;
the first serializer is configured to convert the aggregation result into a first serial signal, and transmit the first serial signal to the first deserializer through the optical fiber; and
the first deserializer is configured to receive the first serial signal, perform deserialization on the first serial signal, and transmit a signal obtained by the deserialization to the image processing unit.

5. The device according to claim 1, wherein the head-mounted display device further comprises a second serializer and a color camera, and the host computer comprises an image processing unit and a second deserializer; the second serializer is connected to the color camera;
the second serializer is configured to convert original data acquired by the color camera into a second serial signal, and transmit the second serial signal to the second deserializer through the optical fiber; and
the second deserializer is configured to receive the second serial signal, perform deserialization on the second serial signal, and transmit a signal obtained by the deserialization to the image processing unit.

6. The device according to claim 1, wherein the host computer further comprises an image processing unit and a third serializer, and the head-mounted display device further comprises a third deserializer; the image processing unit is connected to the third serializer, and the third deserializer is connected to the display screen;
the third serializer is configured to convert the target image into a third serial signal, and transmit the third serial signal to the third deserializer through the optical fiber; and
the third deserializer is configured to receive the third serial signal, perform deserialization on the third serial signal, and transmit a signal obtained by the deserialization to the display screen.

7. The device according to claim 1, wherein the device for extended reality further comprises a cable; the head-mounted display device further comprises a controller; the host computer comprises an image processing unit; the image processing unit is connected to the controller through the cable, and the controller is connected to the plurality of sensors;
the image processing unit is configured to form a synchronization signal, causing the synchronization signal to be transmitted to the controller through the cable;
the controller is configured to generate a first control signal, to control the plurality of sensors to perform data acquisition through the first control signal; and the controller is further configured to receive a feedback signal formed after the plurality of sensors perform data acquisition, and obtain a second control signal based on the feedback signal and the synchronization signal, to transmit the second control signal to the image processing unit through the cable.

8. The device according to claim 7, wherein the image processing unit is further configured to calculate the received original data based on the second control signal and the synchronization signal, to obtain the target image, and a third control signal that is associated with the target image; the third control signal is transmitted to the controller through the cable; and
the controller is further configured to control, based on the third control signal, the display screen to display the target image.

9. The device according to claim 8, wherein the second control signal comprises a timestamp of the original data; and the third control signal comprises a timestamp of the target image.

10. The device according to claim 8, wherein the head-mounted display device further comprises a speech acquisition unit and an audio playback unit, and the speech acquisition unit and the audio playback unit are both connected to the controller;
the controller is further configured to generate a fourth control signal, wherein the fourth control signal is used to control the speech acquisition unit to perform speech acquisition, to obtain first speech information; the controller is further configured to receive the first speech information, obtain second speech information based on the first speech information and the synchronization signal, and transmit the second speech information to the image processing unit through the cable;
the image processing unit is further configured to calculate the received original data based on the second control signal, the synchronization signal, and the second speech information, to obtain the target image, and the third control signal and an audio signal that are associated with the target image; the target image, and the third control signal and the audio signal that are associated with the target image are transmitted to the controller through the cable; and
the controller is further configured to transmit the audio signal to the audio playback unit, causing the audio playback unit to play the audio information.

11. The device according to claim 1, wherein the host computer further comprises a power supply and a direct current-direct current converter, and the head-mounted display device further comprises a power supply management integrated circuit;
the power supply is connected to the direct current-direct current converter; and
the direct current-direct current converter is connected to the power supply management integrated circuit through a cable.

12. A method for extended reality, performed by a device for extended reality, the device for extended reality comprises: a head-mounted display device, a host computer, and an optical fiber connected between the head-mounted display device and the host computer, wherein the head-mounted display device comprises a plurality of sensors, an aggregation unit, and a display screen; at least some of the sensors are connected to the aggregation unit;
wherein the method comprises:
acquiring, by the plurality of sensors, original data;
aggregating, by the aggregation unit, the original data acquired by the sensors connected thereto, to obtain an aggregation result, causing the aggregation result to be transmitted through the optical fiber;
receiving data transmitted through the optical fiber, determining a target image based on the received data, and transmitting, by the host computer, the target image to the head-mounted display device through the optical fiber; and
displaying, by the display screen of the head-mounted display device, the target image.

13. The method according to claim 12, wherein the sensors connected to the aggregation unit comprise at least one of the following:
an eye-tracking sensor, a gesture camera, a pose sensor, and a time-of-flight sensor.

14. The method according to claim 12, further comprising:
aggregating, by the aggregation unit, the original data acquired by the sensors connected thereto, to obtain the aggregation result.

15. The method according to claim 12, wherein the head-mounted display device further comprises a first serializer, and the host computer comprises an image processing unit and a first deserializer; the first serializer is connected to the aggregation unit; the first deserializer is connected to the image processing unit;
the first serializer is configured to convert the aggregation result into a first serial signal, and transmit the first serial signal to the first deserializer through the optical fiber; and
the first deserializer is configured to receive the first serial signal, perform deserialization on the first serial signal, and transmit a signal obtained by the deserialization to the image processing unit.

16. The method according to claim 12, wherein the head-mounted display device further comprises a second serializer and a color camera, and the host computer comprises an image processing unit and a second deserializer; the second serializer is connected to the color camera;
the second serializer is configured to convert original data acquired by the color camera into a second serial signal, and transmit the second serial signal to the second deserializer through the optical fiber; and
the second deserializer is configured to receive the second serial signal, perform deserialization on the second serial signal, and transmit a signal obtained by the deserialization to the image processing unit.

17. The method according to claim 12, wherein the host computer further comprises an image processing unit and a third serializer, and the head-mounted display device further comprises a third deserializer; the image processing unit is connected to the third serializer, and the third deserializer is connected to the display screen;
the third serializer is configured to convert the target image into a third serial signal, and transmit the third serial signal to the third deserializer through the optical fiber; and
the third deserializer is configured to receive the third serial signal, perform deserialization on the third serial signal, and transmit a signal obtained by the deserialization to the display screen.

18. The method according to claim 12, wherein a device for extended reality comprises a cable; the head-mounted display device further comprises a controller; the host computer comprises an image processing unit; the image processing unit is connected to the controller through the cable, and the controller is connected to the plurality of sensors;
the image processing unit is configured to form a synchronization signal, causing the synchronization signal to be transmitted to the controller through the cable;
the controller is configured to generate a first control signal, to control the plurality of sensors to perform data acquisition through the first control signal; and the controller is further configured to receive a feedback signal formed after the plurality of sensors perform data acquisition, and obtain a second control signal based on the feedback signal and the synchronization signal, to transmit the second control signal to the image processing unit through the cable.

19. The method according to claim 18, wherein the image processing unit is further configured to calculate the received original data based on the second control signal and the synchronization signal, to obtain the target image, and a third control signal that is associated with the target image; the third control signal is transmitted to the controller through the cable; and
the controller is further configured to control, based on the third control signal, the display screen to display the target image.

20. The method according to claim 19, wherein the second control signal comprises a timestamp of the original data; and the third control signal comprises a timestamp of the target image.
